(19) United States
(12) Patent Application Publication
(10) Pub. No.: US 2002/0070880 A1
(43) Pub. Date: Jun. 13, 2002

(54) Audible stop light advance warning system

(76) Inventor: Alexander B. Dotson, Ruckersville, VA (US)

Correspondence Address: Parker & DeStefano, 300 Preston Ave Suite 300, Charlottesville, VA, 22902, US

(21) Appl. No.: 09/950,998

(22) Filed: Sep. 13, 2001

Related U.S. Application Data
(60) Provisional application No. 60/235,653, filed on Sep. 26, 2000.

(51) Int. Cl. G08G 1/00

(52) U.S. Cl. 340/901; 340/907

(57) ABSTRACT

A method of providing an early warning system for vehicles approaching traffic lights is disclosed that uses at least one transmitter, or transceiver, on the traffic light and a receiver, or transceiver, in each of vehicle. The transmitters transmit a signal at prior to the traffic light changing color during a predetermined cycle, generally a single sequence of red, green, and amber light changes. The vehicle receiver activates at least one alarm or indicator thereby notifying the driver of the action required. The transmitter and receiver can contain algorithms that control information transmitted and the response of the display panel. The vehicle transceiver can be connected to the on board computer system to receive and read data from the vehicle. When conditions, such as ice, prevent the vehicle from operating correctly, the algorithm transmits to the light receiver the need to delay the color change.

### BACKGROUND OF THE INVENTION

1. Field of the Invention

This invention relates to an advance-warning signal for use in trucks and other large and/or heavy vehicles with extended stopping distances.

2. Brief Description of the Prior Art

Truck drivers have a point of no return whereby it is virtually impossible to stop a truck. This point of no return is reached well in advance, distance wise, from the point of no return for a car. Therefore, unless the truck is a sufficient distance from the intersection when the amber warning light is activated, it is impossible to stop in time. The amount of time it takes to stop a truck depends upon the load, or lack of load, topography and speed. If the driver realizes he is at the point of no return at the exact time the light is changing to amber, he must either run the red light or risk causing an accident in an attempt to stop.

### SUMMARY OF THE INVENTION

A method of providing an early warning system for vehicles approaching traffic lights is disclosed that uses at least one transmitter on the traffic light and a receiver in each of vehicle. In one embodiment, each of the transmitters transmits a signal prior to the traffic light turning amber during a predetermined cycle, generally a single sequence of red, green, and amber light changes. The receiver on the vehicle, activates at least one alarm, such as an audio or visual, thereby notifying the driver of the need to stop. In a second embodiment, the transmitter transmits the remaining time left on the current light color, and a display panel displays the color of the current light and the time remaining on that light. This will enable the driver to know exactly how long the light will remain the current color and enable decisions to be safely made. The color indicator can be any number of methods.

In a third embodiment, the transmitter and receiver, or transceivers, contain algorithms that control information transmitted and the response of the display panel. The algorithm in the transceiver on the traffic light checks the light color and if the color has changed since the last check, the time log is reset to 0. However, if the color has not changed the algorithm checks the time log and subtracts the time in the log from a preprogrammed activation time for that color to determine the remaining active time for that color. The remaining active time, along with the preprogrammed distance of the light transceiver from the stop line, is transmitted in a data packet.

When the vehicle transceiver comes in range and receives the signal, the vehicle algorithm is activated and checks the light color. If the active light color is red, the algorithm calculates the remaining distance between the truck and the stop line and calculates the time it would take to stop and compares that time to the remaining active time of the current light. If the stop time is less than the remaining active time, a panel indicates no action needs to be taken, however if the remaining stop time is greater than the remaining active time the system indicates the need to slow down or stop.

If the active light color is green, the algorithm calculates the remaining distance between the truck and the stop line and compares the remaining active time of the light to the travel time. If the active time of the light is less than the time required to travel the remaining distance then the algorithm indicates a need to stop. If, however, the active time of the light is greater than the remaining travel time, the panel indicates no action is required;

When the active light color is amber, the algorithm calculates the remaining distance between the truck and the stop line and compares the remaining active time to the travel time. If the active time is less than the remaining distance then the algorithm indicates a need to stop. If the active time of said light is greater than the remaining distance, the algorithm indicates no action is required.

In an alternate embodiment, the vehicle transceiver is connected to the on board computer system to receive and read data from the vehicle. When conditions, such as ice, prevent the vehicle from operating correctly, the algorithm transmits to the light receiver the need to delay the color change.

### BRIEF DESCRIPTION OF THE DRAWINGS

The advantages of the instant disclosure will become more apparent when read with the specification and the drawings, wherein:

FIG. 1 is a side view of a truck having a receiver approaching a light having a transmitter; and

FIG. 2 is front view of a receiver display;

FIG. 3 is a flow chart of an example algorithm for an interactive system; and

FIG. 4 is a flow chart of an example algorithm for an interactive system incorporating the delayed amber.

### DETAILED DESCRIPTION OF THE INVENTION

The disclosed system consists of a pair of transceivers, or receiver and transmitter, which would serve to warn vehicles of an impending red light through use of at least an audible indicator. Although reference is made herein to the first two embodiments incorporating a transmitter and receiver while the second two embodiments utilize transceivers, all embodiments can use the transceiver and only embodiments requiring two way communication, such as FIG. 4, will require a transceiver. Although most applicable to semi-tractor trailers, buses, heavy trucks and other large vehicles that have difficulty stopping, the alarm can also be used in automobiles to alert drivers. The description herein will make reference to trucks, however it should be noted that the disclosed is also applicable to automobiles, buses or other vehicle types, and that reference to trucks is for ease of description and does not limit the scope of the invention. The disclosed is most applicable to the light change from green to amber, however the system can be set to transmit notification at any point in a predetermined light cycle. Additionally, as referred to herein a cycle is a single sequence of green, amber and red, however at any applicable time period this can be programmed as a cycle.

The large, heavier trucks have an extended stopping distance, in comparison with a car, due to vehicle and cargo weight. The disclosed system provides a warning to vehicles containing the receiver that the light will be turning amber within a predetermined period of time. This advanced warning will enable a trucker sufficient time to stop the vehicle prior to the light turning red or the vehicle entering the intersection.

The system would consist of a transmitter, or light transceiver, installed at all applicable traffic lights that is connected to, or timed with, the electronic timer on that specific set of traffic lights. Although the illustration herein indicates a single traffic light with a transmitter, individual transmitters can be installed on each of the lights within a localized set, all connected to either individual or centralized timers. Depending upon the transmitter or transceiver, a single unit can be used that transmits from a centralized location over 360 degrees or individual narrow bandwidth transmitters aimed at each oncoming traffic lane can be used for each light or light set. When a single transmitter is being used, care must be taken to ensure that the indication of light change is being directed appropriately.

In the embodiment illustrated in FIG. 1, the transmitter 12 of the system 10 is placed on the exterior of the traffic light 16. Preferably new lights are manufactured with the transmitter as an internal feature, however, the embodiment illustrated in this figure enables existing lights to benefit from the safety features of the disclosed system. Whether the system is internal or external to the light, the benefits and method of working will be similar and any changes from interior to exterior applications will be obvious to those skilled in the art.

In one embodiment, the transmitter 12 sends out a signal at a predetermined period of time prior to the activation of the amber light. The timing for activating the warning signal, in advance of the amber, is manually programmed based on the speed limit and topography. The calculation of the initialization of the warning signal must take into consideration the maximum distance required for stopping and allow for driver reaction time. To avoid confusion, as soon as the light turns to amber, the signal ceases transmission until the next cycle.

The trucks 18 are provided with a receiver 14 placed in the front window, or other convenient location. The receiver 14 can be provided with a light, audio alarm, or combination thereof, to warn the driver that the light will be turning and he must start stopping the truck. As soon as the receiver 14 receives the signal from the transmitter 12, the alarms are activated. It is preferable that an audible alarm is included to immediately alert the driver.

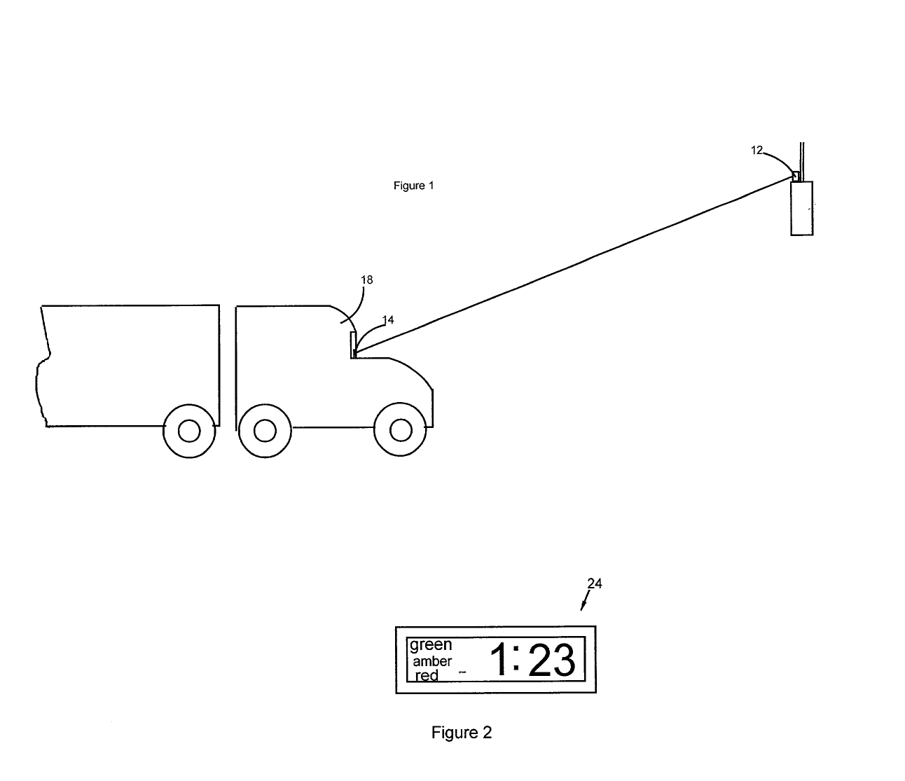

In FIG. 2 illustrates the indicator light of a second embodiment where the transmitter is programmed to provide a countdown as to the amount of time remaining in the cycle of each light. The example receiver 24 illustrated has a readout that provides a countdown clock and color indicators, thereby giving the driver the time remaining and color of the light. Although green, amber and red are all illustrated in the figure, it should be noted that information can be provided on any number of colors. Additionally, although the words, red, amber and red, are written the current can be indicated by lights for the words, time, background, or any other method chosen by the manufacturer.

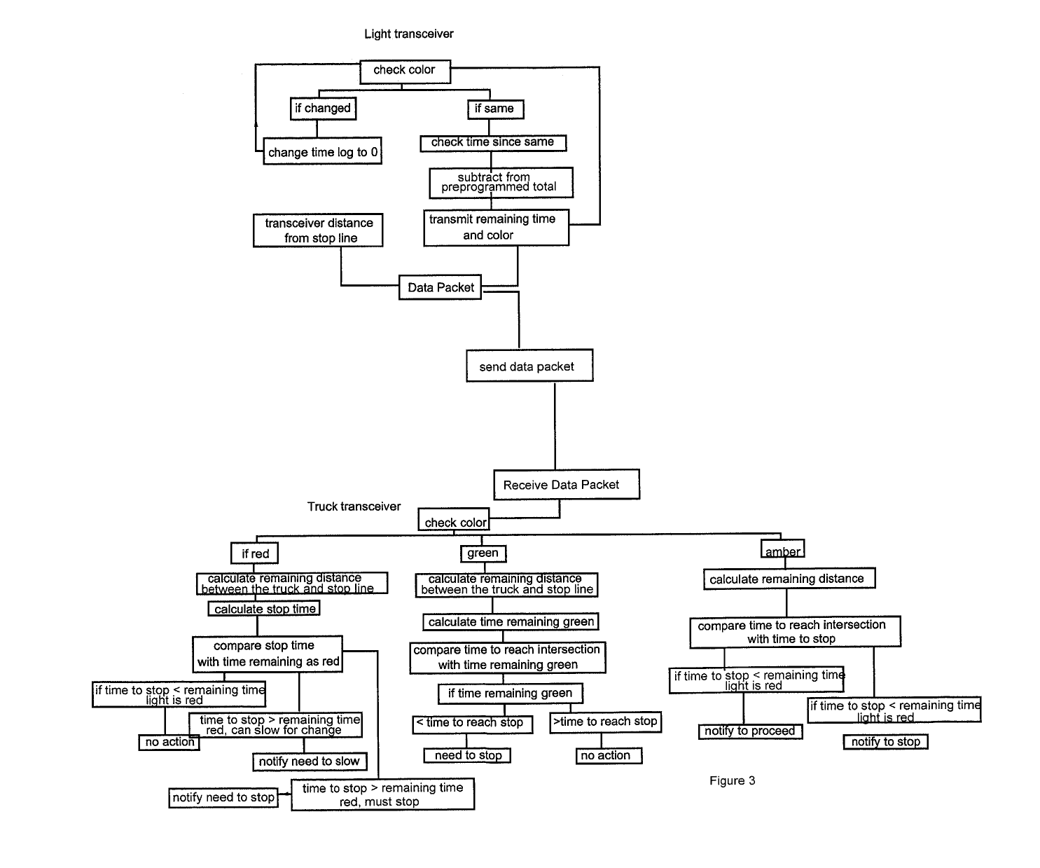

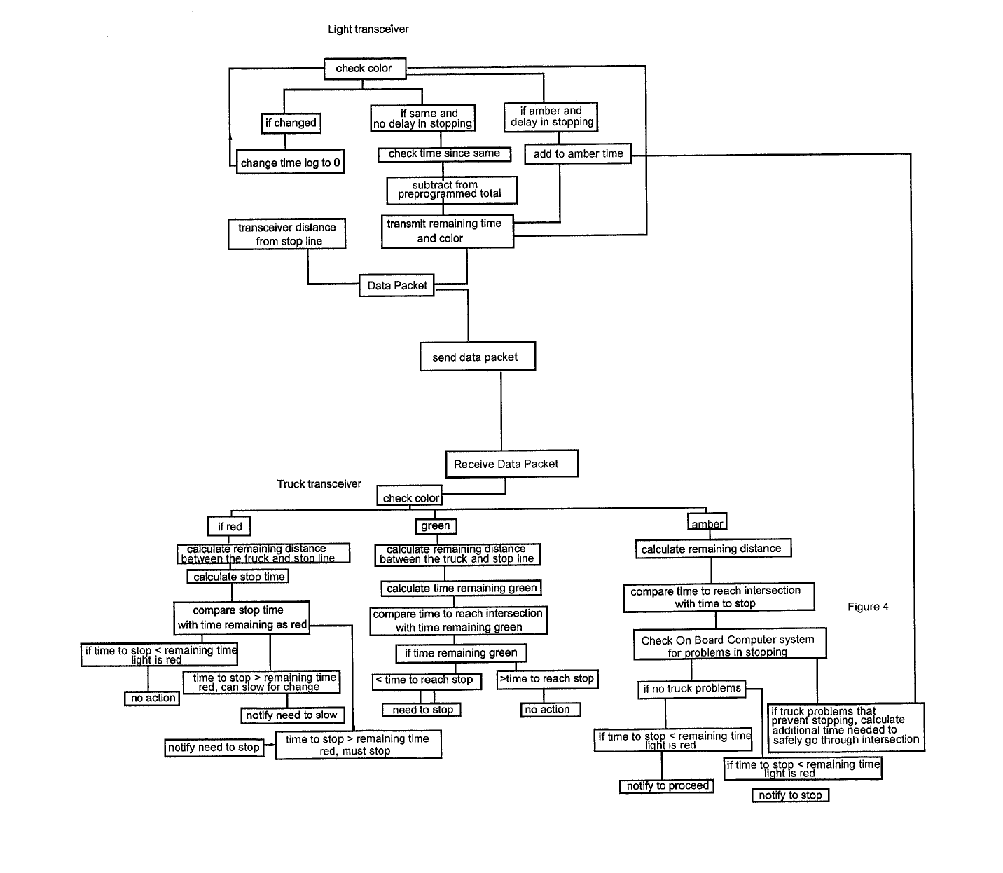

In an alternate embodiment of the notification system, illustrated in the algorithm flow chart of FIG. 3, transceivers having micro processing chips are used. The algorithms disclosed herein are examples, however other methods of achieving the same results can be used. The traffic light transceiver light transmits a series of data packets with each packet containing at least the current color of the light, how much time before the light changes and how many feet the transmitter is from the intersection stop line. By including the distance from the stop line, the light transceiver provides the truck transceiver with a more accurate location since the distances calculated by the truck transceiver are based upon transceiver to transceiver.

The transceiver within the truck receives the data packet, calculates the distances and times, and displays the data to the driver. The amount of data capable of being calculated or displayed is dependent upon the internal programming of the receiver chip. In a “smart ” truck transceiver, the type and weight of the cab, without a trailer, can be programmed in. Once a trailer is added, this fact is either entered manually or electronically through the electrical connections necessary for connecting a trailer. The presence and weight of a load can be added manually or through available electronic methods. With this data stored, the truck transceiver can determine, based on the information sent by the light transceiver and combined with the trucks status, if it will be necessary for the truck stop at the light and, if so, when the truck should start to stop. To determine the distance between the truck and the stop line, the truck transceiver calculates the time it takes to send and receive a signal from the light transceiver, based on the current travel speed. Since the computer chips are able to communicate in nanoseconds, the data can be transmitted and calculated in sufficient time for the truck driver to make a decision. The data can be displayed on a LED or other type screen and audio alarms can also be included.

In the flow chart of FIG. 3 the light transceiver checks the color of the light multiple times per second. In the event the light has changed, the transceiver acknowledges the change by setting the time log to 0. If the light is the same, the transceiver checks the time log to determine how long the light has been that color and then subtracts that time from the preprogrammed overall time that the light remains the current color. That calculation is then included in to the data packet to be sent to the truck transceiver. Also included in the data packet is the transceiver's distance from the stop line as well as the topography. Therefore, a truck receiving the messages will know that it is 400 feet from the stop line and will be going downhill just prior to the stop line. This is a constant and therefore needs no calculation or updating. Since the color is checked and the calculations performed multiple times per second, the time delay between transmissions of the data packet and the actual timing of the light can be measured in nanoseconds.

As illustrated in the second portion of the flow chart of FIG. 3, the truck transceiver initially receives the data packet containing the color, remaining time of the light within that color and the distance to the stop line. The vehicle transceiver initially checks the color. If the light is red, the remaining distance between the truck or other vehicle and the stop line is calculated. The vehicle transceiver knows how long it will take for the vehicle to stop at the current speed, taking into consideration the topography as supplied by the light transceiver. The time it will take to stop within the remaining distance is then compared to the remaining time the light will remain red. If the light will change before the truck reaches the intersection, the driver knows he will not need to stop. If the vehicle will reach the intersection before the light changes to green, the driver is warned that he will have to stop or slow, depending upon the time remaining, speed of the truck, etc. This is calculated by the vehicle transceiver and indicated on the display screen to the driver.

If the light is green, again the distance between the truck and the stop line is calculated and compared with the time the light will remain green. If the time the light remains green is greater than the time it takes the truck to reach the intersection, the driver knows there is no need to stop for the light. If, however, the time it takes to reach the intersection is greater than the period of time the light remains green, the driver knows to start applying the breaks to stop. Since it is preferable for the drivers of big trucks not to come to a complete stop, the algorithm can also calculate, and display, the speed of travel that the truck would need to enable it to be at the stop line after the light has turned green. In this way, a driver would know that if he slowed from 45 mph to 22 mph, the truck would not be required to come to a complete stop.

In instances where the light is amber when the driver initially receives a signal, the truck transceiver calculates the remaining distance and compares that remaining distance with the time it will take the truck to stop. Based on whether or not the truck can safely stop, the driver is notified as to stopping or proceeding.

If desired, the calculations for the green light can include the amber when making the decision. This will depend upon the safety standards and can include such considerations as topography, truck type, weather, etc. It should be noted that weather conditions can also be programmed into the truck transceiver to allow for rain, snow, etc. Additionally, with the availability of computerized maps, the road construction, i.e. gravel, pavement, etc., can also be taken into consideration through downloading the data from the map program.

In the embodiment illustrated in the example algorithm of FIG. 4, the system takes full advantage of the electronics within the vehicle and checks the on board computer system to determine whether there are any problems associated with stopping in time during the amber or green light. If there are problems, such as icy conditions, wet leaves, etc and the ABS brakes indicate a problem, the vehicle transceiver notifies the light transceiver of the need to delay the green or amber light. This notification can automatically delay the light by a preprogrammed unit of time or, alternatively, can include the amount of time required for the vehicle to pass safely through the intersection. When calculating the delay period, the system can either account for the additional time the amber light will add to the green, or exclude that calculation, thereby extending the green light to enable the truck to transverse the intersection. To prevent drivers from randomly using the delayed light function, it is preferable that the signal is in response to the electronics within the vehicle.

The allowances necessary for topography are preferably programmed into the light transceiver. Although the truck transceiver can read from the internal electronic system of some trucks, this would not be applicable to all trucks and should not be relied upon. In order to accommodate older trucks where the truck speed is not electronically accessible to the disclosed system, the speed limit should be included in the light transceiver transmission. This enables the truck to calculate stopping times based on the standard speed limit and makes the system universally compatible for all age trucks.

It should be noted that any method of communication between the light and the truck can be utilized, i.e. RF, IRF, Bluetooth, or any current methods. Additionally other calculations that can enhance the driving of vehicles that are affected by the sequencing and timing of lights can be calculated and displayed to the driver. Other desirable calculations will be obvious to those skilled in the art.

What is claimed is:

1. A method of providing an early warning system for vehicles approaching traffic lights having at least one transmitter on said traffic light and a receiver in each of said vehicles, each of said at least one transmitter transmitting a signal at at least one preprogrammed point during a predetermined cycle of said traffic light, said signal being received by said receiver.

2. The method of claim 1 wherein said cycle is a single sequence of red, green, and amber light changes.

3. The method of claim 2 wherein said at least one preprogrammed point is prior to said light turning the next color in sequence.

4. The method of claim 1 wherein said transmitted signal received by said receiver activates an alarm.

5. The method of claim 1 further comprising a display panel, said display panel displaying data from said transmitter.

6. The method of claim 5 wherein a visual alarm is displayed on said display panel.

7. The method of claim 5 wherein said transmitter a portion of said data is color of said light and time light remains in a current color.

8. The method of claim 4 wherein said alarm is audio.

9. The method of claim 1 wherein each of said at least one transmitter transmits on a narrow bandwidth toward an oncoming traffic lane.

10. The method of claim 7 wherein multiple traffic lights are in communication with each of said at least one transmitter.

11. The method of claim 1 wherein said transmitter is a first transceiver and said receiver is a second transceiver.

12. The method of claim 9 wherein each of said first transceiver and said second transceiver are controlled by algorithms.

13. The method of claim 10 wherein said first transceiver algorithm checks said light color and if a first color has changed a time log is set to 0 and if said first color has not changed said algorithm checks said time log and subtracts said time log from preprogrammed activation time for said first color thereby determining the remaining active time for said first color.

14. The method of claim 11 wherein said system transmits said remaining active time for said first color and the preprogrammed transceiver distance from said stop line in a data packet.

15. The method of claim 12 wherein said second transceiver algorithm checks said light color and
if the active light color is red, said algorithm calculates the remaining distance between the truck and the stop line, calculates the stop time and compares said stop time and said remaining active time and if the stop time is less than the remaining active time, no action is taken and if the remaining stop time is greater than the remaining active time, no action is indicated however if the remaining distance is greater that the active time the system indicates a need to slow down;
if the active light color is green, said algorithm calculates the remaining distance between the truck and the stop line and compares said remaining active time of said light to the travel time and if the active time is less than the remaining distance then said algorithm indicates a need to stop and if the active time of said light is greater than the remaining distance, no action is indicated;
if the active light color is amber, said algorithm calculates the remaining distance between the truck and the stop line and compares said remaining active time to the travel time and if the active time is less than the remaining distance then said algorithm indicates a need to stop and if the active time of said light is greater than the remaining distance, no action is indicated.

16. The method of claim 15 further comprising communication with an on board computer system, said on board computer system providing said vehicle transceiver with current status of said vehicle, said transceiver incorporation said status of said vehicle in said calculations.

17. The method of claim 16 wherein said on board computer system indicating an inability to stop in sufficient time for a light change, said vehicle transceiver transmits to said light transceiver notification to hold said light in a current color for a predetermined period of time, thereby enabling said vehicle to safely transverse an intersection.

16. A method of providing an early warning system for vehicles approaching traffic lights having at least one transmitter on said traffic light and a receiver in each of said vehicles, each of said at least one transmitter transmitting a signal at prior to said light changing color during a predetermined cycle, said cycle being a single sequence of red, green, and amber light changes of said traffic light, said signal being received by said receiver, said transmitted signal activating at least one indicator.

17. A method of providing an early warning system for vehicles approaching traffic lights having at least one light transceiver on said traffic light and a vehicle transceiver in each of said vehicles, each of said at least one light transceiver transmitting a signal at at least one preprogrammed periods during a predetermined cycle, said cycle being a single sequence of red, green, and amber light changes of said traffic light, said signal being determined by a first algorithm, said first algorithm checking said light color and if a first color has changed, setting a time log to 0 and if said first color has not changed said algorithm checking said time log and subtracting said time log from a preprogrammed activation time for said first color thereby determining the remaining active time for said first color,
said algorithm transmitting said remaining active time for said first color and the preprogrammed light transceiver distance from said stop line in a data packet,
said vehicle transceiver receiving said signal activating a vehicle algorithm to checks said light color and
if the active light color is red, said algorithm calculating the remaining distance between the truck and the stop line, calculating the stop time and comparing said stop time and said remaining active time and if the stop time is less than the remaining active time, indicating no action to be taken and if the remaining stop time is greater than the remaining active time, indicating a need to slow down;
if the active light color is green, said algorithm calculating the remaining distance between the truck and the stop line and comparing said remaining active time of said light to the travel time and if the active time is less than the remaining distance then said algorithm indicates a need to stop and if the active time of said light is greater than the remaining distance, indicating no action is required;
if the active light color is amber, said algorithm calculating the remaining distance between the truck and the stop line and comparing said remaining active time to the travel time and if the active time is less than the remaining distance then said algorithm indicating a need to stop and if the active time of said light is greater than the remaining distance, said algorithm indicating no action is required.
